(19) United States
(12) Patent Application Publication
(10) Pub. No.: US 2007/0171461 A1
(43) Pub. Date: Jul. 26, 2007

(54) Network facsimile transmission originating device, program, and method, and network facsimile relay device, program, and method

(76) Inventors: Masato Sugii, Kawasaki-shi (JP); Takanori Masui, Ebina-shi (JP); Makoto Takada, Ebina-shi (JP); Nobumi Kusano, Ebina-shi (JP)

Correspondence Address: GAUTHIER & CONNORS, LLP, 225 FRANKLIN STREET, SUITE 2300, BOSTON, MA, 02110, US

(21) Appl. No.: 11/403,079

(22) Filed: Apr. 12, 2006

(30) Foreign Application Priority Data
Sep. 22, 2005 (JP) 2005-276102

(51) Int. Cl. G06F 3/12

(52) U.S. Cl. 358/1.15; 358/402

(57) ABSTRACT

A network facsimile transmission originating device includes a first mail generator that generates a first e-mail which includes a scanned image to be facsimiled and designates a fax number of a fax destination in a destination mail address field, an encryption unit that encrypts, using a public key of a relay device, at least a portion of the first e-mail generated by the first mail generator, a second mail generator that generates a second e-mail which includes the encrypted first e-mail and designates a mail address of the relay device in a destination mail address field, and a transmitter that transmits the second e-mail generated by the second mail generator to the relay device via a network.

### PRIORITY INFORMATION

This application claims priority to Japanese Patent Application No. 2005-276102 filed on Sep. 22, 2005, which is incorporated herein by reference in its entirety.

### BACKGROUND

1. Technical Field

The present invention relates to a technique for carrying out a facsimile transmission via an electronic mail (e-mail) transmission, and more particularly to a technique for performing encryption using public key cryptography when executing the e-mail transmission.

2. Related Art

In recent years, Internet facsimile where a facsimile function is partly or entirely substituted by the Internet has become widely available. With this function, transmission and reception processing is controlled by e-mail addresses designated by the provisions of RFC (Request For Comment) 3192. For example, in an off ramp transmission, by transmitting an e-mail having a scanned image attached thereto to the e-mail address “FAX=012345@relay.fax.com”, a user can cause a device having the domain name “relay.fax.com” to execute a facsimile transmission of the scanned image to the facsimile number “012345”.

### SUMMARY

According to one aspect, the present invention provides a network facsimile transmission originating device. The network facsimile transmission originating device includes a first mail generator that generates a first e-mail which includes a scanned image to be facsimiled and designates a fax number of a fax destination in a destination mail address field, an encryption unit that encrypts, using a public key of a relay device, at least a portion of the first e-mail generated by the first mail generator, a second mail generator that generates a second e-mail which includes the encrypted first e-mail and designates a mail address of the relay device in a destination mail address field, and a transmitter that transmits the second e-mail generated by the second mail generator to the relay device via a network.

According to another aspect, the present invention provides a computer-readable storage medium storing a program for transmitting a fax executable by a computer to perform a function including generating a first e-mail which includes a scanned image to be facsimiled and designates a fax number of a fax destination in a destination mail address field, encrypting, using a public key of a relay device, at least a portion of the first e-mail generated by the first mail generator, generating a second e-mail which includes the encrypted first e-mail and designates a mail address of the relay device in a destination mail address field; and transmitting the generated second e-mail to the relay device via a network.

According to a further aspect, the present invention provides a network facsimile transmission originating method. The method includes generating a first e-mail which includes a scanned image to be facsimiled and designates a fax number of a fax destination in a destination mail address field, encrypting, using a public key of a relay device, at least a portion of the first e-mail generated by the first mail generator, generating a second e-mail which includes the encrypted first e-mail and designates a mail address of the relay device in a destination mail address field, and transmitting the generated second e-mail to the relay device via a network.

According to a still further aspect, the present invention provides a network facsimile relay device. The network facsimile relay device includes a receiver that receives a second e-mail, a decryption unit that decrypts a first e-mail which is included in the received second e-mail and is at least partly encrypted using a public key, the decryption unit performing the decryption by means of a private key corresponding to the public key, an acquisition unit that acquires a fax number of a fax destination from a destination mail address field of the decrypted first e-mail, and a transmitter that executes a fax transmission of an image included in the decrypted first e-mail to the fax number acquired by the acquisition unit.

According to another aspect, the present invention provides A computer-readable storage medium storing a program for relaying a facsimile executable by a computer to perform a function including receiving a second e-mail, decrypting a first e-mail which is included in the received second e-mail and is at least partly encrypted using a public key, the decrypting is performed by means of a private key corresponding to the public key, acquiring a fax number of a fax destination from a destination mail address field of the decrypted first e-mail, and executing a fax transmission of an image included in the decrypted first e-mail to the acquired fax number.

According to a further aspect, the present invention provides a network facsimile relay method. The method includes receiving a second e-mail, decrypting a first e-mail which is included in the received second e-mail and is at least partly encrypted using a public key, the decrypting is performed by means of a private key corresponding to the public key, acquiring a fax number of a fax destination from a destination mail address field of the decrypted first e-mail, and executing a fax transmission of an image included in the decrypted first e-mail to the acquired fax number.

### BRIEF DESCRIPTION OF THE DRAWINGS

Embodiments of the present invention will be described in detail based on the following figures, wherein:

FIG. 1 is a block diagram schematically showing an example configuration of a system according to the present invention;

FIGS. 2A and 2B are diagrams showing a flow of processing in an originating device; and

FIGS. 3A and 3B are diagrams showing a flow of processing in a relay device.

### DETAILED DESCRIPTION

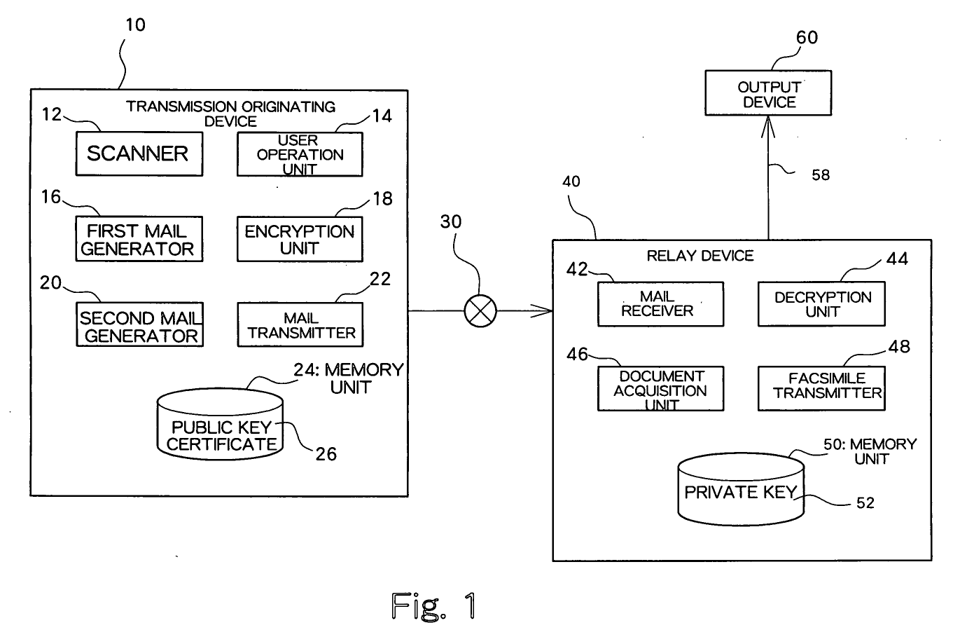

FIG. 1 is a block diagram showing a system configuration according to an embodiment of the present invention. In FIG. 1, a transmission originating device 10, the Internet 30, relay device 40, and output device 60 are shown as the main components of the system. Although each of the originating device 10, relay device 40, and output device 60 in the present embodiment is assumed to be a multifunction machine having the functions of a copier (scanner and printer) and a facsimile machine, only the characteristic features of each device are shown in FIG. 1 in order to clearly illustrate the functions that each device serves in the system of the present embodiment.

The transmission originating device 10 includes a scanner 12, user operation unit 14, first mail generator 16, encryption unit 18, second mail generator 20, mail transmitter 22, and memory unit 24.

The scanner 12 optically reads a document formed on a sheet of paper so as to generate a scanned image, or image data. The user operation unit 14 is provided with a liquid crystal display having a user input function, an input button, and the like. A user can select via the user operation unit 14 an operation such as a normal fax transmission (i.e., transmission using fax lines only) and a fax transmission via the Internet 30. When instructing a fax transmission, the user can designate the output device 60 from an address book or by directly inputting an address. The user can also configure settings of the relay device 40 and select whether or not to employ encryption.

The first mail generator 16 generates, in accordance with the provisions of RFC 3192, an e-mail for instructing the relay device 40 to execute a fax transmission (this e-mail is referred to as the first e-mail). In other words, the first mail generator 16 generates an e-mail which, if transmitted as a normal e-mail, would cause the relay device 40 to execute a fax transmission in compliance with the provisions of Internet fax. More specifically, the first e-mail is generated by attaching thereto an image generated by the scanner 12, and including in the destination mail address field a mail address having incorporated therein a fax number of the output device 60 and having a domain name acquired by the relay device 40.

The encryption unit 18 encrypts the first e-mail using public key cryptography. More specifically, the encryption unit 18 encrypts the first e-mail using an appropriately created common key, and subsequently encrypts this common key by means of a public key certificate 26 stored in the memory unit 24. This public key certificate 26 is one that has been issued corresponding to an e-mail address used by the relay device 40 for receiving a facsimile request, and is acquired by the originating device 10 as necessary from a certification authority on the Internet 30. With this arrangement, decryption of the encrypted common key and the encrypted first e-mail cannot be performed by any devices other than the relay device 40 which owns the corresponding private key.

The second mail generator 20 generates an e-mail (this e-mail is referred to as the second e-mail) which includes in the destination mail address field the mail address of the relay device 40, and which has attached thereto the encrypted first e-mail and the encrypted common key. The mail transmitter 22 sends the second e-mail to the relay device 40 via the Internet 30.

The relay device 40 is the device which is designated as the destination of the second e-mail. The relay device 40 includes a mail receiver 42, decryption unit 44, document acquisition unit 46, facsimile transmitter 48, and memory unit 50.

The mail receiver 42 performs reception of e-mails including, in addition to the above-described second e-mail, e-mails addressed to registered individual users and e-mails generated in accordance with the provisions of RFC 3192. After reception of the second e-mail, the decryption unit 44 decrypts the encrypted first e-mail attached to the second e-mail. More specifically, the decryption unit 44 first decrypts the encrypted common key attached to the second e-mail by means of the private key 52 stored in the memory unit 50, and subsequently decrypts the first e-mail using the obtained common key.

The document acquisition unit 46 retrieves the image attached to the first e-mail and acquires the fax number written in the destination mail address field of the first e-mail. Further, the facsimile transmitter 48 executes a fax transmission of the image to the output device 60 denoted by this fax number via the facsimile line 58.

The output device 60 receives the fax transmission via the facsimile line and prints out the received image.

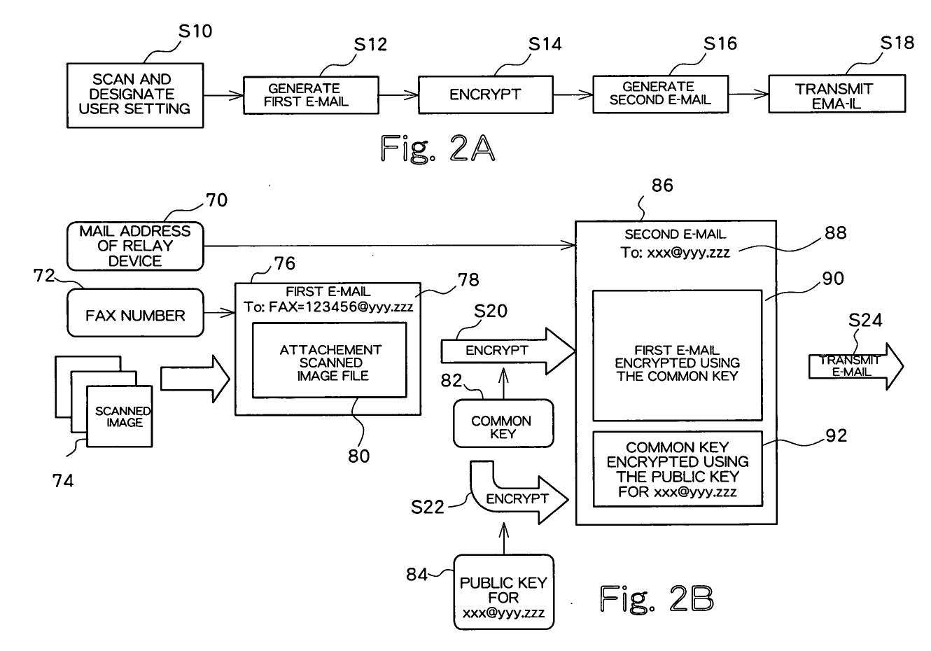

Referring to FIGS. 2A and 2B, the processing flow in the originating device 10 is next described. FIG. 2A is a flowchart showing the outline of the processing, while FIG. 2B is a diagram showing details corresponding to the flowchart of FIG. 2A.

As can be seen in FIG. 2A, in the originating device 10, according to user instructions from the user operation unit 14, a document to be transmitted is scanned using the scanner 12, and various settings for the transmission are set (S10). Subsequently, a first e-mail is generated by the first mail generator 16 (S12), the first e-mail is encrypted by the encryption unit 18 (S14), a second e-mail is generated by the second mail generator 20 (S16), and the second e-mail is transmitted by the mail transmitter 22 (S18).

As shown in FIG. 2B, step S10 of FIG. 2A specifically includes designating the mail address 70 of the relay device 40, designating the fax number 72 of the output device 60, and generating a scanned image 74. When, for example, the designated fax number 72 is “123456” and the domain name of the designated mail address 70 of the relay device 40 is “yyy.zzz”, a first e-mail 76 having the mail address “FAX=123456@yyy.zzz” indicated in the destination mail address field 78 is generated in step S12. Further, an attachment scanned image file 80 which is based on the scanned image 74 is incorporated into the first e-mail 76.

In step S14 of FIG. 2A, the entire first e-mail 76 is encrypted using a common key 82 (S20 in FIG. 2B). Step S14 further includes encrypting the common key 82 (S22 in FIG. 2B) using a public key 84 issued corresponding to the mail address 70 “xxx@yyy.zzz” of the relay device 40 designated in step S10. In the subsequent step S16, a second e-mail 86 is generated. The mail address “xxx@yyy.zzz” of the relay device 40 designated in step S10 is indicated in the destination mail address field 88 of the second e-mail 86. Further, the generated second e-mail 86 has attached thereto the encrypted first e-mail 90 encrypted using the common key, along with the encrypted common key 92. This generated second e-mail 86 is transmitted to the relay device 40 via the Internet 30 (S24 in FIG. 2B).

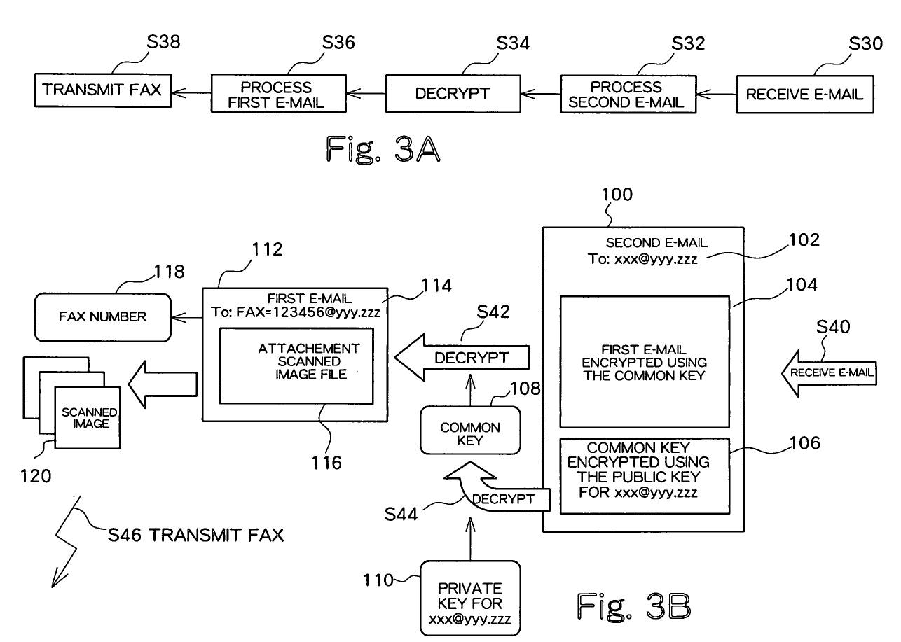

Referring to FIGS. 3A and 3B, the processing flow in the relay device 40 shown in FIG. 1 is next described. FIG. 3A is a flowchart showing the outline of the processing, while FIG. 3B is a diagram showing details corresponding to the flowchart of FIG. 3A.

As can be seen in FIG. 3A, in the relay device 40, the mail receiver 42 receives various e-mails (S30). The received e-mails are sorted according to the respective mail addresses, and the second e-mail is subjected to the subsequent sequence of processing (S32). That is, decryption processing is performed with respect to the second e-mail by the decryption unit 44 (S34). The document acquisition unit 46 then extracts the fax number and the image from the decrypted first e-mail (S36). The facsimile transmitter 48 finally transmits the image to the extracted fax number (S38).

As shown in FIG. 3B, in the second e-mail 100 obtained by receiving e-mails (S40), the e-mail address “xxx@yyy. zzz” of the relay device 40 is indicated in the destination mail address field 102. Further, the second e-mail 100 has attached thereto the encrypted first e-mail 104 encrypted using the common key, along with the encrypted common key 106 encrypted using the public key for “xxx@yyy.zzz”. In the decryption step S34 of FIG. 3A, the encrypted common key 106 is decrypted using the private key 110 for “xxx@yyy.zzz” (S44 in FIG. 3B), then the decrypted and obtained common key 108 is used to decrypt the encrypted first e-mail 104 (S42 in FIG. 3B). As a result, the decrypted first e-mail 112 is obtained. In the subsequent step S36, the fax destination number 118 (“123456”) is extracted from the mail address “FAX=123456@yyy.zzz” indicated in the destination mail address field 114 of the first e-mail 112. Further, the scanned image 120 is acquired from the attachment scanned image file 116. Finally, in step S38 of FIG. 3A, a fax transmission of the scanned image 120 to the extracted fax number 118 is executed (S46).

While an embodiment in which the mail address is designated in compliance with the provisions of RFC 3192 was explained in the above description, the mail address may be designated according to any other provisions as long as the relay device can determine from the mail address that a fax transmission should be executed and to which fax number the transmission should be directed. Further, while it was assumed in the above description that the originating device, the relay device, and the output device are multifunction machines having a copying function, the above-described processing may alternatively be accomplished by other types of machines. For example, a general PC provided with peripheral devices such as a scanner and a printer can be employed to carry out a processing equivalent to the above by installing a predetermined program in the PC.

Next, various modifications of the embodiment of the present invention will be described.

According to one aspect of the present invention, the network facsimile transmission originating device may be implemented by controlling one or more hardware units having calculating functions (i.e., computers) by means of a software (program). In one example, the network fax transmission originating device may be implemented by installing necessary software in a hardware unit such as a fax machine (device which mainly functions to perform fax transmissions and receptions), scanner (device which mainly functions to perform scans), multifunction machine (device having multiple functions of scanner, printer, fax, and the like), and PC (personal computer). The scanned image is image data generated by reading, using a scanner, a document (which may include a diagram, photograph, and the like) formed on a sheet. While the scanned image is typically expressed in a raster (bit map) format, the scanned image may alternatively be expressed in other formats such as a vector format. Further, the scanner may be integrated inside the device which originates transmission of the scanned image, or the scanner may alternatively be provided as a separate unit. The network facsimile transmission originating device sends the scanned image by e-mail to the relay device, and causes the relay device to execute a fax transmission to the fax destination.

The first mail generator generates the first e-mail. The scanned image is included in the first e-mail by attachment or by being embedded into the body of the e-mail. Further, the fax number of the fax destination supplied by a user instruction or the like is designated in the destination mail address field of the first e-mail. While this designation of fax number can be performed in any format which can be recognized by the relay device, the designation is typically performed in compliance with standard provisions such as those of RFC 3192. Use of standard provisions is advantageous because this enables processing in the relay device to be performed using a general application software or by employing an existing function of the relay device. It should be noted that multiple fax numbers may be incorporated in the destination mail address field of the first e-mail.

The encryption unit encrypts at least a portion of the first e-mail using the public key of the relay device. Typically, the public key of the relay device is acquired from a public key certificate issued by a certification authority or the like. The second mail generation unit generates the second e-mail which includes the encrypted first e-mail and has the mail address of the relay device written in the destination mail address field. The first e-mail may be included in the second e-mail by attachment or by being embedded into the body of the second e-mail. A multiple number of first e-mails may be included in the second e-mail. Furthermore, mail addresses of a multiple number of relay devices may be included in the destination mail address field of the second e-mail.

The order of processing by the encryption unit and the second mail generation unit can be arbitrarily selected. In other words, the second mail generator may generate the second e-mail after the encryption unit completes encryption, or alternatively, the encryption unit may partly or entirely encrypt the first e-mail (and may also encrypt a portion of the second e-mail) after the second mail generator incorporates the first e-mail into the second e-mail. A digital signature according to public key cryptography may be placed on the first e-mail or the second e-mail. The mail transmitter transmits the thus created second e-mail via a network such as the Internet and the local area network.

According to this arrangement, the first e-mail including the scanned image can be safely transmitted to the relay device by employing public key cryptography, while an instruction to execute fax transmission can be supplied to the relay device using the destination mail address field of the first e-mail. In addition, in contrast to mail address designation in an ordinary Internet facsimile, it is unnecessary to change the mail address written in the destination mail address field of the second e-mail even when the fax destination is changed as long as the same relay device is used. Accordingly, the same public key (public key certificate) can be repeatedly used to perform encryption, such that transmissions of instructions for various processing, in particular, can be made at a low cost and an increased speed.

According to another aspect of the present invention, the network facsimile relay device may be implemented by controlling one or more hardware units having calculating functions by means of software (program). In one example, the network fax relay device maybe implemented by installing necessary software in a hardware unit such as a fax machine (device which mainly functions to perform fax transmissions and receptions), multifunction machine (device having multiple functions of scanner, printer, fax, and the like), and PC (personal computer). The network facsimile relay device may be implemented in a machine which simultaneously serves as the network facsimile transmission originating device.

The relay device receives the second e-mail transmitted via the network. The second e-mail includes the first e-mail encrypted by public key cryptography. The decryption unit decrypts the first e-mail using a corresponding private key. The acquisition unit acquires the fax number of the fax destination from the destination mail address field of the decrypted first e-mail based on a predetermined rule or the like. Subsequently, the facsimile transmitter executes a fax transmission of the image included in the decrypted first e-mail to the acquired fax number. In other words, the image is transmitted according to the facsimile protocol via a telephone line or an alternative channel (such as an IP telephone or wireless telephone network).

What is claimed is:

1. A network facsimile transmission device comprising:
a first mail generator that generates a first e-mail which includes a scanned image to be facsimiled and designates a fax number of a fax destination in a destination mail address field;
an encryption unit that encrypts, using a public key of a relay device, at least a portion of the first e-mail generated by the first mail generator;
a second mail generator that generates a second e-mail which includes the encrypted first e-mail and designates a mail address of the relay device in a destination mail address field; and
a transmitter that transmits the second e-mail generated by the second mail generator to the relay device via a network.

2. The network facsimile transmission device as defined in claim 1, wherein
the first mail generator designates the fax number in the destination mail address field in accordance with a provision of Request For Comment 3192.

3. The network facsimile transmission device as defined in claim 1, wherein
the first mail generator designates, in the destination mail address field of the first e-mail, a single fax number corresponding to a single fax destination.

4. The network facsimile transmission device as defined in claim 1, wherein
the first mail generator designates, in the destination mail address field of the first e-mail, a plurality of fax numbers corresponding to a plurality of fax destinations.

5. The network facsimile transmission device as defined in claim 1, wherein
the second mail generator generates the second e-mail which includes a plurality of encrypted first e-mails.

6. A computer-readable storage medium storing a program for transmitting a fax executable by a computer to perform a function comprising:
generating a first e-mail which includes a scanned image to be facsimiled and designates a fax number of a fax destination in a destination mail address field;
encrypting, using a public key of a relay device, at least a portion of the first e-mail generated by the first mail generator;
generating a second e-mail which includes the encrypted first e-mail and designates a mail address of the relay device in a destination mail address field; and
transmitting the generated second e-mail to the relay device via a network.

7. A network facsimile transmitting method, comprising:
generating a first e-mail which includes a scanned image to be facsimiled and designates a fax number of a fax destination in a destination mail address field;
encrypting, using a public key of a relay device, at least a portion of the first e-mail generated by the first mail generator;
generating a second e-mail which includes the encrypted first e-mail and designates a mail address of the relay device in a destination mail address field; and
transmitting the generated second e-mail to the relay device via a network.

8. A network facsimile relay device, comprising:
a receiver that receives a second e-mail;
a decryption unit that decrypts a first e-mail which is included in the received second e-mail and is at least partly encrypted using a public key, the decryption unit performing the decryption by means of a private key corresponding to the public key;
an acquisition unit that acquires a fax number of a fax destination from a destination mail address field of the decrypted first e-mail; and
a transmitter that executes a fax transmission of an image included in the decrypted first e-mail to the fax number acquired by the acquisition unit.

9. The network facsimile relay device as defined in claim 8, wherein
the fax number is designated in the destination mail address field of the first e-mail in accordance with a provision of Request For Comment 3192; and
the acquisition unit acquires the fax number in accordance with a provision of Request For Comment 3192.

10. The network facsimile relay device as defined in claim 8, wherein
a single fax number corresponding to a single fax destination is designated in the destination mail address field of the first e-mail; and
the acquisition unit acquires the fax number.

11. The network facsimile relay device as defined in claim 8, wherein
a plurality of fax numbers corresponding to a plurality of fax destinations are designated in the destination mail address field of the first e-mail;
the acquisition unit acquires the plurality of fax numbers; and
the transmitter executes fax transmissions of the image included in the first e-mail to the plurality of fax numbers.

12. The network facsimile relay device as defined in claim 8, wherein
the second e-mail includes a plurality of first e-mails;
the decryption unit decrypts the plurality of first e-mails;
the acquisition unit acquires a plurality of fax numbers from the plurality of first e-mails; and
the transmitter executes fax transmissions, to the acquired plurality of fax numbers, of images included in the corresponding first e-mails, respectively.

13. A computer-readable storage medium storing a program for relaying a facsimile executable by a computer to perform a function comprising:
receiving a second e-mail;
decrypting a first e-mail which is included in the received second e-mail and is at least partly encrypted using a public key, the decrypting is performed by means of a private key corresponding to the public key;
acquiring a fax number of a fax destination from a destination mail address field of the decrypted first e-mail; and
executing a fax transmission of an image included in the decrypted first e-mail to the acquired fax number.

14. A network facsimile relay method, comprising:
receiving a second e-mail;
decrypting a first e-mail which is included in the received second e-mail and is at least partly encrypted using a public key, the decrypting is performed by means of a private key corresponding to the public key;
acquiring a fax number of a fax destination from a destination mail address field of the decrypted first e-mail; and
executing a fax transmission of an image included in the decrypted first e-mail to the acquired fax number.
